(19) United States
(12) Patent Application Publication
(10) Pub. No.: US 2004/0011256 A1
(43) Pub. Date: Jan. 22, 2004

(54) Luminous cementitious composition and methods of making and using the same

(76) Inventor: Thomas D. Beimel, Brookville, PA (US)

Correspondence Address: BURNS, DOANE, SWECKER & MATHIS, L.L.P., P.O. Box 1404, Alexandria, VA, 22313-1404, US

(21) Appl. No.: 10/414,083

(22) Filed: Apr. 16, 2003

Related U.S. Application Data
(60) Provisional application No. 60/372,946, filed on Apr. 16, 2002.

(51) Int. Cl. C09K 11/08; C04B 14/26

(52) U.S. Cl. 106/712; 252/301.4 F; 252/301.4 R

(57) ABSTRACT

The invention relates to a luminous composition including hydraulic cement, a polymer, limestone and micro-capsules of an alkaline earth metal aluminate encapsulated in a light-transmitting resin, light-transmitting glass or combination thereof. The invention is also directed to a method of making a luminous composition. The method includes cooling an alkaline earth metal aluminate encapsulated in a light-transmitting resin, light-transmitting glass or combination thereof to a temperature of about −250° F. to about −350° F. and rendering the encapsulated aluminate into a powder comprising micro-capsules of the alkaline earth metal aluminate encapsulated in the light-transmitting resin, light-transmitting glass or combination thereof, wherein the micro-capsules range in size from about 0.7 μm to about 200 μm. The method then includes combining the aluminate powder with hydraulic cement, a polymer and limestone.

### RELATED APPLICATION DATA

This application claims the benefit of U.S. Provisional Application No. 60/372,946, filed Apr. 16, 2002, entitled “Luminous Coating,” the entire disclosure of which is incorporated by reference.

### BACKGROUND

1. Field of the Invention

The present invention is directed to luminous compositions that can absorb energy when illuminated and luminesce or glow when in darkness. In particular, the invention is directed to alkaline earth metal aluminate luminous cementitious compositions and methods of making and using such compositions.

2. Description of the Related Art

This present invention arose from an effort to give a luminous quality to previously successful cementitious materials such as, for example, coating materials sold under the KanKote™ brand name, referred to hereafter as the KanKote™ coating. The KanKote™ material is generally a blend of hydraulic cement with other ingredients such as limestone, silica sand, and a polymer. U.S. Pat. Nos. 4,708,978 and 4,614,755 suggest previous variations of the KanKote™ coating material, and polymer substitutions in this material that can be made to adjust hardness, durability and other characteristics.

Cement-based compositions enjoy broad application in a variety of construction materials including, for example, mortars, grouts, wall plasters, pool plasters, stucco, roofing materials, surface coatings, patches and self-leveling compounds. The addition of luminescent materials, such as fluorescent and phosphorescent materials, to cementitious materials is also known.

Phosphorescence refers to the process by which a molecule is excited by light to a higher electronic state and then undergoes a radiationless transition to a state of different multiplicity from which it decays, after some delay, to the ground state. The emitted light is normally of longer wavelength than the exciting light because vibrational energy has been dissipated. In fluorescent processes, luminescence is caused by the absorption of radiation at one wavelength followed by nearly immediate reradiation at a different wavelength that ceases at once when the incident radiation stops. The key distinction, therefore, is that the emission of absorbed radiation in phosphorescence can continue long after the cessation of excitation, or source, radiation. In contrast, in fluorescence, the emission is very short lived after the source excitation has been terminated. Hence, luminescence in fluorescence requires that the excitation be employed at all times, whereas luminescence from phosphorescence requires the excitation source to “charge” the material and the luminescence can be detected for long periods of time after the source excitation has stopped.

Previous patents have described the use of fluorescent materials. For example, U.S. Pat. No. 4,172,063 describes an abrasion resistant reflective marking composition which uses fluorescent pigments and headlights or back lights as an excitation source. Also, U.S. Pat. No. 5,314,536 describes preparing luminous constructions materials by embedding fluorescent luminescent chunks into cementitious materials. Additionally, U.S. Pat. No. 5,849,218, describes a fluorescent pool coating.

Previous patents have also described the use of phosphorescent materials. U.S. Pat. No. 6,005,024, for example, describes a phosphorescent epoxy overlay which uses rare earth doped calcium aluminates. Additionally, U.S. Pat. Nos. 5,424,006 and 5,665,793 describe incorporating a phosphorescent material into hydrocarbon based systems such as paint. Furthermore, U.S. patent application No. 20030051638 describes cementitious products that include rare earth doped calcium aluminates.

Alkaline earth metal aluminates have succeeded other phosphorescent materials as a preferred source of luminescence. U.S. Pat. No. 6,375,864, for example, explains that, unlike other phosphors, alkaline earth metal aluminates do not decompose upon exposure to ultraviolet radiation and exhibit an afterglow that is about 3 to 12 times brighter than comparable sulfide phosphorescent phosphors at 10 minutes after stimulation, and about 17 to 37 times brighter at 100 minutes after stimulation. The '864 patent also discloses that these phosphors continue to exhibit a visible afterglow 15 to 24 hours or more after a single stimulation.

Despite these advantages, alkaline earth metal aluminates have been avoided as a source of luminescence in water-based materials, such as cementitious materials, because they are known to be deactivated by water. These aluminates have also been avoided because of their susceptibility to deactivation upon contact with contaminants such as, for example, metal contaminants, that are produced when the aluminate is rendered into a powder for mixing with water-based compositions such as, for example, cementitious compositions.

As a result, materials such as, for example, coating materials that incorporate alkaline earth metal aluminates as a luminescent material have generally not been water-based, have generally required at least two coatings, and have required materials that are expensive enough so that the coating costs range upward from $30 per square foot.

Thus, there is an urgent need for an inexpensive luminous material that includes an alkaline earth metal aluminate that is effectively preserved from contact with water and/or contaminants.

### SUMMARY OF THE INVENTION

The present invention provides luminous compositions that include micro-capsules of an alkaline earth metal aluminate encapsulated in a light-transmitting, heat-resistant, resin, glass, combination thereof or the like. The present invention also provides methods of making and using such materials.

In particular, the present invention provides a luminous composition that includes a quantity of micro-capsules of alkaline earth metal aluminate such as, for example, strontium aluminate. The micro-capsules can range in size from about 0.7 μm to about 200 μm. The effectiveness of the micro-capsules in providing desired luminescence is believed to be based on their ability to preserve the encapsulated aluminate from contact with water and/or metal contaminants while allowing light to transmit into and out from the encapsulated aluminate.

The present invention also provides a method of making such a composition. The method can include cooling an encapsulated alkaline earth metal aluminate to between about −250° F. and about −350° F. and rendering the encapsulated aluminate into a powder that includes particles (i.e., micro-capsules) having a size ranging from about 0.7 μm to about 200 μm. Finally, the process can include combining the powder with various materials including, for example, at least one of cement, a polymer, limestone, silica, a curing decelerant, an anti-foaming agent, a thickener and a whitener.

A luminous composition, according to the present invention, can include cement and micro-capsules comprising an alkaline earth metal aluminate encapsulated in a light-transmitting resin, light-transmitting glass or combination thereof.

Another luminous composition, according to the present invention, can include a hydraulic cement, a polymer, limestone and micro-capsules comprising an alkaline earth metal aluminate encapsulated in a light-transmitting resin, light-transmitting glass or combination thereof. In exemplary embodiments, the composition can include at least one of a strontium aluminate as the alkaline earth metal aluminate, a polyvinyl acetate polymer as the polymer, a silica glass as the light-transmitting glass, an acrylic resin as the light-transmitting resin, silica and less than about 30% fractured alkaline earth metal aluminate.

Another luminous composition, according to the present invention, can include hydraulic cement, a polymer, limestone, a curing decelerant, an anti-foaming agent and micro-capsules comprising an alkaline earth metal aluminate encapsulated in a light-transmitting resin, light-transmitting glass or combination thereof. In exemplary embodiments, the composition can include at least one of silica, a polyvinyl acetate polymer as the polymer, a silica glass as the light-transmitting glass, an acrylic resin as the light-transmitting resin, a strontium aluminate as the alkaline earth metal aluminate and less than about 30% fractured alkaline earth metal aluminate.

Yet another luminous composition, according to the present invention, can include hydraulic cement, silica sand, a polymer, a thickener, a whitener and micro-capsules comprising an alkaline earth metal aluminate encapsulated in a light-transmitting resin, light-transmitting glass or combination thereof. In exemplary embodiments, the composition can include at least one of a silica glass as the light-transmitting glass, an acrylic resin as the light-transmitting resin, a vinyl acetate ethylene copolymer as the polymer, a strontium aluminate as the alkaline earth metal aluminate and less than about 30% fractured alkaline earth metal aluminate.

An alkaline earth metal aluminate powder, according to the present invention, can include a plurality of micro-capsules comprising an alkaline earth metal aluminate encapsulated in a light-transmitting resin, light-transmitting glass or combination thereof, wherein the micro-capsules range in size from about 0.7 μm to about 200 μm and wherein less than about 30% of the encapsulated aluminate is fractured.

A method of making an alkaline earth-metal aluminate powder, according to the present invention, can include cooling an alkaline earth metal aluminate encapsulated in a light-transmitting resin, light-transmitting glass or combination thereof to between about −250° F. and about −350° F. and rendering the encapsulated alkaline earth metal aluminate into a powder comprising particles (i.e., micro-capsules) comprised of the alkaline-earth metal aluminate encapsulated in the light-transmitting resin, light-transmitting glass or combination thereof, wherein the particles range in size from about 0.7 μm to about 200 μm and wherein less than about 30% of the encapsulated aluminate is fractured. When the aluminate is encapsulated in a light-transmitting resin, the method can further include heating the powder to a temperature about equal to or less than the resin's glass transition temperature.

A method of making a luminescent composition, according to the present invention, can include cooling an alkaline earth metal aluminate encapsulated in a light-transmitting resin, light-transmitting glass or combination thereof to between about −250° F. and about −350° F. and rendering the encapsulated alkaline earth metal aluminate into a powder comprising particles (i.e., micro-capsules) comprised of the alkaline earth metal aluminate encapsulated in the light-transmitting resin, light-transmitting glass or combination thereof, wherein the particles range in size from about 0.7 μm to about 200 μm. The method can further include combining the powder with hydraulic cement, a polymer, and limestone. When the aluminate is encapsulated in a light-transmitting resin, the method can further include heating the powder to a temperature about equal to or less than the resin's glass transition temperature. In exemplary embodiments, the method can include at least one of a strontium aluminate as the alkaline earth metal aluminate, a silica glass as the light-transmitting glass, an acrylic resin as the light-transmitting resin, and less than about 30% fractured aluminate.

### DETAILED DESCRIPTION

This invention arose-from an effort to-give a luminous quality to previously successful cementitious compositions such as, for example, a coating material sold under the brand name KanKote™. The invention includes adding to such compositions a luminescent material that enables the composition to absorb energy when illuminated and to thereafter glow or luminesce when darkened.

Early experiments established that alkaline earth metal aluminates in a powder form cannot be readily added to water-based materials such as, for example, the KanKote™ coating material. Generally, it was discovered that alkaline earth metal aluminates are not capable of being added in a powder form to water-based materials because the aluminates are sensitive to water. Moreover, when rendered into a powder, alkaline earth metal aluminates are susceptible to deactivation by contaminants such as, for example, metal contaminants, that are generated when the aluminates are rendered into a powder.

In particular, it was discovered that the luminescent glow capacity of alkaline earth metal aluminates such as, for example, strontium aluminates diminishes significantly when in contact with water and/or metal contaminants. This led to experiments with extruded polymeric pellets containing an alkaline earth metal aluminate. These experiments, however, proved that aluminate-containing polymer pellets are unsatisfactory. Specifically, besides forming unacceptably lumpy coatings, the luminescence of the pellets diminished rapidly after exposure to water. Another problem discovered in early experiments is that smaller pellets of alkaline earth metal aluminate have a lessened capacity for luminescent glow and therefore become prohibitively expensive when used in sufficient quantity to provide an adequate luminescent glow. Moreover, mixtures of alkaline earth metal aluminate pellets, such as, for example, strontium aluminate pellets in water-based materials, such as the KanKote™ coating material, became aesthetically unappealing and, in the case of the KanKote™ material, reduced the material's fire-resistant properties.

After several unsuccessful experiments, I began a succession of experiments involving micro-capsules of alkaline earth metal aluminate. This succession of experiments gradually established a form in which an alkaline earth metal aluminate can be successfully incorporated into a water-based material such as, the KanKote™ material, to provide the desired luminescence. These experiments were intended to provide luminescence for water-based materials, such as the KanKote™ coating material, without otherwise affecting desirable properties of the material such as, for example, water-resistance, durability, fire resistance, skid resistance, non-toxicity and aesthetic appearance. Additionally, the experiments were intended to provide such a material that would have a low application cost when compared to alternative, conventional materials.

Although early experiments with extruded polymer pellets containing an alkaline earth metal aluminate indicated that smaller pellets would provide less luminescence than larger ones, I nevertheless tried a micro-encapsulated form of an alkaline earth metal aluminate mixed with a water-based cementitious material. I was surprised to find that the micro-capsules of the alkaline earth aluminate in a much smaller form than pellet forms provided an adequate luminescent glow.

An ultimately successful mixture added to a water-based material, such as a KanKote™ material, a quantity of a powder comprising micro-capsules of an alkaline earth metal aluminate such as, for example, a strontium aluminate, encapsulated in a light-transmitting, heat-resistant, resin, glass, combination thereof or the like. As used herein, the term “alkaline earth metal aluminate” refers to any alkaline earth metal aluminate material whose luminescent properties are diminished or deactivated when in contact with water and/or metal contaminants and that absorbs energy when illuminated and thereafter glows or luminesces when darkened. Alkaline earth metal aluminates, in accordance with present invention, can, of course, include any aluminate derived from the alkaline earth metals: beryllium (Be), Magnesium (Mg), Calcium (Ca), Strontium (Sr), barium (Ba) and radium (Ra).

The micro-capsules of the present invention can range in size from about 0.7 μm to about 200 μm, preferably about 1 μm to about 200 μm, more preferably about 5 μm to about 200 μm, most preferably about 10 μm to about 200 μm. In exemplary embodiments, however, the micro-capsules can range in size from about 0.7 μm to about 175 μm, from about 0.7 μm to about 150 μm or about 0.7 to about 135 μm. The particle size of the micro-capsules of the present invention is generally measured using a classifier that uses a screen or sieve, which only permits passage of particles having a certain size. Suitable sieves and screens include, but are not limited to, sieve scales, U.S. sieves, Tyler Standard sieves, international test sieves, grizzly screens, revolving screens, mechanical shaking screens, vibrating screens, mechanically vibrated screens, electrically vibrated screens, oscillating screens, reciprocating screens, gyrating screens, gyrating riddles, combinations thereof and the like. Descriptions of suitable sieves/screens and classifying equipment can be found in Section 19, pages 19-1 to 19-65 of Perry's Chemical Engineering Handbook, Seventh Edition (1997), the entire disclosure of which is hereby incorporated by reference.

It is believed that the effectiveness of the micro-capsules in providing desired luminescence is based on their ability to preserve the encapsulated aluminate from contact with water and/or metal contaminants while allowing light to transmit into and out from the encapsulated aluminate. In exemplary embodiments, the specific gravity of the micro-capsules can be adjusted to approximate the specific gravities of other ingredients the material so that the micro-capsules remain evenly dispersed during shipment of the material in a powder form.

Luminous compositions, according to the invention, can include a variety of materials including, but not limited to, hydraulic cement, a polymer, limestone, silica, a curing decelerant, an anti-foaming agent, a whitener, a thickener and micro-capsules of an alkaline earth metal aluminate encapsulated in a light-transmitting, heat-resistant, resin, glass, combination thereof or the like.

As used herein, the term “encapsulated” means that about 97% to about 100% of the aluminate is covered by the encapsulating material. In exemplary embodiments, substantially all of the aluminate is about 100% covered by the encapsulating material.

Micro-capsules of strontium aluminate are available, for example, under the Lumilux™ brand name and are sold under the product names GID 300 Series and GID SR Series by an Australian company named Bought Deal, LLC. The micro-capsules made by Bought Deal, LLC use silica as the encapsulating material and contain strontium aluminate as the alkaline earth metal aluminate. The compositions of the present invention, however, are in no way limited to silica micro-capsules. Any light-transmitting resin, glass, combination thereof or the like can be used.

In fact, while the micro-capsules from Bought Deal, LLC can be used in compositions of the present invention, micro-capsules made in accordance with the present invention are much less costly to make. That is, it is believed that the micro-capsules made by Bought Deal, LLC are atomized using equipment that can cost from about $500,000 to about $4,000,000. By preparing glass-encapsulated micro-particles in accordance with the present invention, however, there is no need for expensive atomizing equipment. Moreover, resin-encapsulated micro-capsules, made in accordance with the present invention, may exhibit properties that make them more desirable in certain applications than the silica glass micro-capsules from Bought Deal, LLC. For example, it has been found that the resin-encapsulated micro-capsules of the present invention are much more durable than the micro-capsules from Bought Deal, LLC. As a result, the resin-encapsulated micro-capsules of the present invention may be better suited for use in applications where the micro-capsules will be subjected to external force or stress.

In addition to the above advantages, micro-capsules made in accordance with the present invention are preserved from contact with water and/or contaminants to a greater extent than the micro-capsules sold by Bought Deal, LLC. That is, it is believed that about 4% to about 8% of the aluminate in a given sample of micro-capsules from Bought Deal, LLC are exposed aluminates (i.e., not effectively preserved from contact with water and/or contaminants). Thus, it is believed that only about 92% to about 96% of the aluminates in a given sample micro-capsules from Bought Deal. LLC are substantially encapsulated. In contrast, about 97% to about 100% of the aluminate in a sample of micro-capsules according to the present invention are substantially encapsulated.

Water-based materials, according to the present invention, can be varied in the type of polymer used in the composition. Suitable polymers according to the present invention, however, can include, but are not limited to, vinyl acetate polymers and copolymers. Various forms of vinyl acetate monomer are sold under the Vinnapas™ name by a U.S. company named Wacker.

Compositions, according to the present invention can also include an anti-foaming agent. One suitable anti-foaming agent is based on, for example, a combination of liquid hydrocarbons, hydrophobic silicic acid, synthetic copolymers and non-ionic emulsifiers. Anti-foaming agents of this type are sold, for example, under the Agitan™ brand name by Munzing Chemie, GmbH. Specifically, Agitan™ P800 or 801 are suitable. An additional example of a suitable anti-foaming agent is an agent sold under the brand name Rhodoline™ 770DD.

Compositions of the present invention can also include a curing decelerant. Suitable curing decelerants include, but are not limited to tartaric acid, cream of tatar, citric acid, sodium glucomate and sodium nitrate.

Compositions of the present invention can also include whiteners. One example of a suitable whitener is a titanium dioxide.

Compositions of the present invention can also include thickeners. One example of a suitable thickener is a methylhydroxypropyl cellulose thickener. Another example of a suitable thickener, is a thickener sold under the Obtibent™ brand name.

The luminous compositions of the present invention, can be used in a number of applications including, for example, decorative and/or safety applications. Depending on the alkaline earth metal aluminate used, luminescence in different colors such as, for example, green and/or blue, is possible.

Furthermore, due to its encapsulated form, the encapsulated aluminate can be readily incorporated into a variety of water-based materials, without an adverse affect on the properties of the materials. In particular, because the aluminate is encapsulated, it can be added to a variety of cementitious materials such as mortars, grouts, pool plasters, wall plasters, cementitious roofing materials, cementitious surface coatings, cement patches and self-leveling compounds.

U.S. patent application No. 20030051638 to Pomeroy, for example, describes suitable water-based compositions that can be used with the encapsulated alkaline earth metal aluminate of the present invention. The disclosure of U.S. patent application No. 20030051638 is hereby incorporated by reference in its entirety. Of course, the compositions disclosed in Pomeroy, made in accordance with the present invention, would include micro-capsules of alkaline earth metal aluminate instead of the non-encapsulated, rare-earth doped calcium aluminate of Pomeroy.

Unlike conventional aluminate coating materials, the compositions of the present invention can provide substantially thicker coatings that can be applied more cost-effectively. That is, coatings made using the compositions of the present invention can have a thickness ranging from about 7 μm to about 30 μm. In contrast, coatings made using conventional aluminate cementitious compositions have a thickness ranging from about 3 μm to about 5 μm. Thus, while a single coating of a composition of the present invention can be effective, conventional compositions require multiple applications to obtain a coating of adequate thickness. As a result, coatings prepared using conventional compositions are more time-consuming and costly to apply.

The present invention also provides a process for producing an alkaline earth metal aluminate powder comprising micro-capsules of an alkaline earth metal aluminate encapsulated in a light-transmitting, heat-resistant, resin, glass, combination thereof or the like. The aluminate powder produced by this process includes less than about 30%, preferably less than about 25%, more preferably less than about 15%, even more preferably less than about 10% and most preferably less than about 3% fractured aluminate, measured in terms of the total number of aluminate particles in a given sample. In the context of the present invention, “fractured” refers to the structure of the encapsulated aluminate and/or the degree of encapsulation. A fractured aluminate is one whose structure is compromised and/or one that is no longer substantially encapsulated so that when contacted by water and/or contaminants the luminescence of the aluminate is diminished or deactivated. Generally, aluminates of the present invention that remain substantially encapsulated when rendered into a powder have structures have not been compromised during processing in a way that would make them susceptible to deactivation by water and/or contaminants.

As a result, the alkaline earth metal aluminate powder of the present invention is much less susceptible to deactivation by water and/or metal contaminants than conventional, unpreserved forms of alkaline earth metal aluminate. In fact, it has been discovered that aluminate powders including particles of comparable size prepared using conventional powder-rendering means include between about 30% and about 50% fractured aluminate.

The process of the present invention minimizes the percentage of fractured alkaline earth metal aluminate by cooling (i.e. freezing) the encapsulated aluminate to between about −250° F. and about −350° F. using, for example, a nitrogen bath so that the encapsulating resin, glass, or combination thereof is made more brittle before being rendered into a powder. In exemplary embodiments, the method includes maintaining the encapsulated aluminate and/or the surrounding environment in which the encapsulated aluminate is being processed at a temperature between about −250° F. and about −350° F. while the encapsulated aluminate is being rendered into a powder. Cooling of the aluminate and/or the surrounding environment during processing can be achieved, for example, by contacting the encapsulated aluminate with nitrogen such as by introducing nitrogen with injectors. By maintaining the temperature between about −250° F. and about −350° F. it is possible to prevent the temperature of the aluminate and/or the surrounding environment from being elevated by heat generated during the size reduction process.

Also, by cooling the aluminate and/or surrounding environment, the process keeps the encapsulated resin, glass or combination thereof brittle. By doing so, the method minimizes the amount of aluminate that is fractured when the encapsulated aluminate is rendered into a powder. In particular, experimental data shows that by cooling the encapsulated aluminate before and during rendering it into a powder, the encapsulating material surrounding the aluminate fractures more rapidly and the resulting powder includes substantially less fractured aluminate than encapsulated aluminate rendered into a powder at higher temperatures, such as room temperature. Thus, while not being limited to any particular theory, it is believed that this is due not only to the brittleness of the encapsulating material, but is also due to the fact that the time needed to fracture and separate the encapsulated aluminate is substantially reduced.

The encapsulated aluminate can be rendered into a powder using any known powder-rendering means including, but not limited to, a hammer mill, a pulverizer and a mill jet. Suitable means for rendering encapsulated aluminate into a powder, in accordance with the present invention, are described, for example, in Section 20, pages 20-1 to 20-89 of Perry's. Chemical Engineering Handbook Seventh Edition (1997), the entire disclosure of which is hereby incorporated by reference.

The powder of the present invention comprises micro-capsules that range in size from about 0.7 μm to about 200 μm in size. In exemplary embodiments, the micro-capsules can range in size from about 0.7 μm to about 135 μm or from about 10 μm to about 125 μm. The size of the particles (micro-capsules) in the powder can, of course, be adjusted to provide desired properties.

Additionally, when the aluminate used is a resin-encapsulated aluminate, the particles (micro-capsules) in the powder may have a clouded or hazed surface after being rendered into the powder form. As a result, the micro-capsules may not luminesce as much as they would if the surface of the encapsulating resin were clear. Thus, when aluminate of the present invention is encapsulated in a light-transmitting resin, the method can include further processing the powder to dehaze the surface of the encapsulating resin after the encapsulated aluminate has been rendered into a powder. Further processing can include heating the powder using, for example, pressurized hot air, to a temperature about equal to or less than the encapsulating resin's glass transition temperature. For example, when the encapsulating resin is an acrylic resin, the powder can be heated to about 212° F. or less. Heating a resin-capsulated aluminate powder in this manner, appears to improve the luminescence of the powder by about 20% to about 30%; This improvement is believed to be due to the de-hazed surface of the encapsulating resin.

Finally, the process of the present invention can include adding the aluminate powder to a variety of materials to produce a luminous composition. Materials to which the powder can be added include, for example, hydraulic cement, a polymer, limestone, silica, anti-foaming agent, a thickener, a whitener and a curing decelerant.

### EXAMPLES

### Example 1

A first mixture involving micro-encapsulated strontium aluminate uses hydraulic cement, vinyl acetate monomer, limestone and strontium aluminate micro-capsules as follows:

Test One—By Weight

16.01 g—hydraulic cement

14.01 g—vinyl acetate monomer (RP224)

60.02 g—limestone

15.01 g—strontium aluminate micro-capsules (G.I.D. 300.2 FS).

105.05 g—total

Powder material for this composition is mixed into about ⅛ cup of water to a consistency of buttermilk for approximately 3 to 5 minutes. The mixture is then allowed to sit for about 1 minute to about 2 minutes and applied to a concrete substrate and to a glass substrate. Drying time is approximately 2 hours. The resulting coating looks similar to other coatings formed with KanKote™ materials, and the coating has no noticeable cracking, dries hard and has good adhesion.

The coating is then exposed to about 10 to about 15 minutes of light, and is thereafter found to glow in the dark for approximately 18 hours with a greenish-yellow color. The coating is then submerged in water after the glow has diminished to be unnoticeable and is then re-exposed to light for approximately 10 to 15 minutes and then observed to glow in the dark for approximately another 14 hours. Preliminary indications show that this composition is a success.

### Example 2

To achieve a harder coating, I then substitute a different acetate monomer in a second test as follows:

Test Two—By Weight

16.01 g—hydraulic cement

14.01 g—vinyl acetate monomer (RE5010M)

45.00 g—limestone

10.01 g—silica

15.01 g—strontium aluminate micro-capsules (G.I.D. 300.2 FS)

100.04 g—total

Following the same mixing and application procedures as used in Test One, a coating material from this composition proves even more successful. The coating is hard upon curing but still retains adhesion, pliability and superior glow characteristics. No visible cracking occurs from shrinking, and the coating produces the surprising advantage of drying faster than regular KanKote™ coatings and being easier to clean.

### Example 3

Following this, I try another experiment with a different form of glass encapsulated strontium aluminate as follows:

Test Three—By Weight

16.01 g—hydraulic cement

14.01 g—vinyl acetate monomer (RE5010N)

48.00 g—limestone

7.00 g—silica

15.00 g—strontium aluminate micro-capsules (G.I.D. Series 4.2B)

100.00 g—total

Using the same mixing and application procedure as for the previous test, the coating that this composition produces is also successful. I notice a possible problem though, because the strontium aluminate micro-capsules appears to settle to the bottom of the mixing container. On checking with the supplier, I find that the specific gravity of the strontium aluminate micro-capsules is adjustable and can be made to more closely approximate the specific gravities of the other solids in the KanKote™ mixture.

Following this discovery, I tried Test Four through Test Seven using different forms of glass-encapsulated strontium aluminate micro-capsules that glow with different colors. Selecting strontium aluminate micro-capsules with a specific gravity of between about 1.15 and about 1.25 significantly reduced the tendency of the micro-capsules to settle in the mixture. The glow characteristics of the blue and the greenish-yellow micro-capsules prove to be generally similar, with the blue color sustaining a somewhat longer visible glow.

### Example 4

From these experiments, I discovered that an exemplary embodiment of a formulation of a KanKote™ material with luminescent strontium aluminate micro-capsules is as follows:

Exemplary Formulation—By Weight

16.01 g—hydraulic cement

14.00 g—vinyl acetate monomer (RE5010N)

48.00 g—limestone

7.00 g—silica

15.00 g—strontium aluminate micro-capsules (G.I.D. 300.2 FS)

100.01 g—total

This material meets the goals of the experimental program. The dry ingredients in the composition can be mixed with water and applied in a single coating. The micro-encapsulation protects the strontium aluminate from contact with water, so that its luminescent capacity is not diminished. The silica-glass walls of the micro-capsules are inert and do not react with other coating ingredients. This helps to preserve the micro-encapsulated strontium aluminate.

These coatings can be made adequately hard by selecting an appropriate vinyl acetate monomer, and the coating is not inclined to crack or fail in its adhesion. The coating can also be made pliable and has a high coefficient of friction to be skid-resistant. The coating is also water-resistant and fire-resistant. Finally, the coating achieves all of these desired qualities while having an application cost of only about $4.00 per square foot, which is significantly less than other luminescent coatings.

### Example 5

Cementitious Composition

16%—white hydraulic cement

14%—vinyl acetate monomer polymer

10%—encapsulated strontium aluminate, green and blue

59.75%—agricultural powder limestone

0.05% to 0.3% tartaric acid (curing decelerant)

0.10% Agitan™ (anti-foaming agent)

When mixing the above composition, a multi-coat process is beneficial. A first coat ratio is between about 10 and about 12 pounds of powdered material added to about one gallon of cool, clean water and mixed for about 2 to about 3 minutes. The mixture is allowed to aerate until air bubbles have dissipated. The coating can then be applied using a suitable applicator, such as a brush, roller combination thereof or the like. A second coat and all subsequent coats, can be prepared using between about 12 to about 17 pounds of powdered material added to about one gallon of cool, clean water and mixed for about 2 to about 3 minutes. The mixture can be allowed to aerate until air bubbles have dissipated. The resulting mixture can then be applied using a suitable applicator, such as a brush, roller, trowel, sprayer, combination thereof or the like.

### Example 6

Cementitious Composition

16%—white hydraulic cement

14%—vinyl acetate monomer polymer

10%—encapsulated strontium aluminate, green and blue

55.25%—agricultural powder limestone

4.5%—clear silica sand

0.05% to 0.3% tartaric acid (curing decelerant)

0.10%—Agitan™ (anti-foaming agent)

When mixing the above composition, a multi-coat process is used. A first coat is prepared by adding about 10 to about 12 pounds of the powdered composition to about one gallon of cool, clean water and mixed for about 2 to about 3 minutes. The mixture is allowed to aerate until bubbles have dissipated. The mixture can then be applied using a brush, roller combination thereof or the like. A second coat and any subsequent coats can be prepared by combining about 12 to about 17 pounds of the powdered composition with about one gallon of cool, clean water and mixing for about 2 to about 3 minutes. The mixture is allowed to aerate until air bubbles have dissipated. The resulting mixture can then be applied using a brush, roller, trowel or sprayer, combinations thereof or the like.

### Example 7

Exemplary Grout Composition

38%—white cement

43.9%—clear silica sand

4%—vinyl acetate ethylene copolymer

10%—encapsulated strontium aluminate, green and blue

0.1%—methyl hydroxy propylcellulose (thickener)

4%—titanium dioxide

When mixing the above composition, about 17 to about 20% water ratio is mixed with the powdered composition to achieve a desired consistency.

### Example 8

Process for Preparing Resin-Encapsulated Strontium Aluminate Powder

I began with a 10% by weight loaded strontium aluminate encapsulated resin pellet. After numerous experiments, I found that the following method was surprisingly successful at rendering the pellets into a powder that was in: a form that maintains both luminous quality and particle size consistency.

First, I froze the pellets in a cryogenic nitrogen bath to a temperature of about −300° F. Next, I fed the frozen pellets into a stainless steel hammer mill using a stainless steel conveying screw that was super-cooled to about −300° F. By keeping the temperature at about −300° F., I found that as the pellets entered the hammer mill, the pellets fractured quickly, thereby reducing the time needed to fracture and separate the pellets inside the mill. During the fracturing, the hammer mill was also super-cooled with nitrogen injectors, thereby maintaining a super-cooled environment at about −300° F. By maintaining the environment at about −300° F., I prevented the heat generated by the milling process from elevating the temperature to a point where the fracturing would break the actual strontium aluminate structure or would introduce metal contamination due to the length of time the pellets had to be in the mill to be rendered into a powder form. Once fractured, the resulting resin-encapsulated strontium aluminate powder comprised micro-capsules having a size between about 10 microns and about 125 microns. Before being rendered into a powder, the pellets were about 0.25 inch in length and about 0.25 inch in diameter. Once the pellets were rendered into a powder form, I found that the surface of the powder particulate (i.e., the surface of the encapsulating resin) was hazed from being fractured inside the hammer mill. As a result of the hazed surface, I found that the luminescence of the encapsulated strontium aluminate micro-capsules was reduced. Thus, in order to increase, and possibly maximize, the phosphorescent quality of the powder, I further processed the powder so that the hazed particulate surface was made more clear. This was achieved by loading the powder into a chamber and introducing pressurized hot air so that the resin-encapsulated strontium aluminate particles were heated to the resin glass transition temperature. By heating the powder in this manner, I noticed a “clearing affect” in the surface at the encapsulating acrylic resin. Additionally, I found that the resulting particles exhibited between about 20% to about 30% more phosphorescence as compared to unheated powder by virtue of the de-hazed particulate surfaces.

While the present invention has been described with reference to specific embodiments, this application is intended to cover those various changes and substitutions that may be made by those of ordinary skill in the art without departing from the spirit and scope of the appended claims.

What is claimed is:

1. A luminous composition, comprising:
cement; and
micro-capsules comprising an alkaline earth metal aluminate encapsulated in a light-transmitting resin, light-transmitting glass or combination thereof.

2. A luminous composition, comprising:
hydraulic cement;
a polymer;
limestone; and
micro-capsules comprising an alkaline earth metal aluminate encapsulated in a light-transmitting resin, light-transmitting glass or combination thereof.

3. The composition of claim 2, wherein the alkaline earth metal aluminate is a strontium aluminate.

4. The composition of claim 2, wherein the polymer is a polyvinyl acetate polymer.

5. The composition of claim 2, wherein the light-transmitting glass is a silica glass.

6. The composition of claim 2, wherein the light-transmitting resin is an acrylic resin.

7. The composition of claim 2, wherein the micro-capsules range in size from about 0.7 μm to about 135 μm.

8. The composition of claim 2, further comprising silica.

9. The composition of claim 2, comprising about 16% by weight hydraulic cement, about 14% by weight polymer, about 45% to about 60% by weight limestone, about 15% by weight micro-capsules of alkaline earth metal aluminate and optionally about 7% to about 10% by weight silica.

10. The composition of claim 2, wherein less than about 30% of the encapsulated aluminate is fractured.

11. A luminous composition comprising:
hydraulic cement;
a polymer;
limestone;
a curing decelerant;
an anti-foaming agent; and
micro-capsules of an alkaline earth metal aluminate encapsulated in a light-transmitting, resin, glass or combination thereof.

12. The composition of claim 11, further comprising silica.

13. The composition of claim 11, wherein the polymer is a polyvinyl acetate polymer.

14. The composition of claim 11, wherein the light-transmitting glass is a silica glass.

15. The composition of claim 11, wherein the light-transmitting resin is an acrylic resin.

16. The composition of claim 11, wherein the micro-capsules range in size from about 0.7 μm and about 200 μm.

17. The composition of claim 11, wherein the alkaline earth metal aluminate is a strontium aluminate.

18. The composition of claim 10, comprising about 16% by weight cement, about 14% by weight polymer, about 55% to about 60% by weight limestone, about 0.15% by weight curing decelerant, about 0.10% by weight anti-foaming agent, about 10% by weight encapsulated alkaline earth metal aluminate and optionally about 4.5% by weight silica.

19. The composition of claim 11, wherein less than about 30% of the encapsulated aluminate is fractured.

20. A luminous composition comprising:
hydraulic cement;
silica sand;
a polymer;
a thickener;
a whitener; and
micro-capsules comprising an alkaline earth metal aluminate encapsulated in a light-transmitting resin, light-transmitting glass or combination thereof.

21. The composition of claim 20, wherein the polymer is a vinyl acetate ethylene copolymer.

22. The composition of claim 20, wherein the light-transmitting glass is a silica glass.

23. The composition of claim 20, wherein the light-transmitting resin is an acrylic resin.

24. The composition of claim 20, wherein the micro-capsules range in size from about 0.7 μm and about 200 μm.

25. The composition of claim 20, wherein the alkaline earth metal aluminate is a strontium aluminate.

26. The composition of claim 20, comprising about 38% by weight cement, about 43.9% by weight silica sand, about 4% by weight polymer, about 0.1% by weight curing decelerant, about 4% by weight titanium dioxide and about 10% by weight encapsulated alkaline earth metal aluminate.

27. The composition of claim 20, wherein less than about 30% of the encapsulated aluminate is fractured.

28. An alkaline earth metal aluminate powder comprising a plurality of micro-capsules of an alkaline earth metal aluminate encapsulated in a light-transmitting resin, glass or combination thereof, wherein the micro-capsules range in size from about 0.7 μm and about 200 μm and wherein less than about 30% of the encapsulated aluminate is fractured.

29. A method of making an alkaline earth metal aluminate powder, the method comprising cooling an alkaline earth metal aluminate encapsulated in a light-transmitting, resin, glass or combination thereof to a temperature of about −250° F. to about −350° F.; and
rendering the encapsulated aluminate into a powder comprising micro-capsules of the alkaline earth metal aluminate encapsulated in the light-transmitting resin, light-transmitting glass or combination thereof, the micro-capsules ranging in size from about 0.7 μm to about 200 μm, wherein less than about 30% of the encapsulated aluminate is fractured.

30. The method of claim 29, wherein when the aluminate is encapsulated in a light-transmitting resin, the method further comprises heating the powder to a temperature about equal to or less than the resin's glass transition temperature.

31. An alkaline earth metal aluminate powder made by the process of claim 29.

32. A method of making a luminous composition, the method comprising cooling an alkaline earth metal aluminate encapsulated in a light-transmitting resin, light-transmitting glass or combination thereof to a temperature of about −250° F. to about −350° F.;
rendering the encapsulated alkaline earth metal aluminate into a powder comprising micro-capsules comprising the alkaline earth metal aluminate encapsulated in the light-transmitting, resin, light-transmitting glass or combination thereof, the micro-capsules ranging in size from about 0.7 μm to about 200 μm; and
combining the aluminate powder with hydraulic cement, a polymer, and limestone to produce a luminous composition.

33. The method of claim 32, wherein when the aluminate is encapsulated in a light-transmitting resin, the process further comprises heating the powder to a temperature equal to or less than the resin's glass transition temperature before adding it to the hydraulic cement, polymer and limestone.

34. The method of claim 32, wherein the alkaline earth metal aluminate is a strontium aluminate.

35. A luminous composition made by the process of claim 32.
